(19) United States
(12) Patent Application Publication
(10) Pub. No.: US 2022/0180214 A1
(43) Pub. Date: Jun. 9, 2022

(54) METHOD, APPARATUS, AND SYSTEM FOR PROVIDING SEMANTIC CATEGORIZATION OF AN ARBITRARILY GRANULAR LOCATION

(71) Applicant: HERE Global B.V., Eindhoven (NL)

(72) Inventors: Christopher CERVANTES, Chicago, IL (US); Srikrishna KOMPELLA, Oak Park, IL (US)

(21) Appl. No.: 17/116,743

(22) Filed: Dec. 9, 2020

(51) Int. Cl. G06N 5/02; G06N 20/00

(52) U.S. Cl. CPC G06N 5/02; G06N 20/00

(57) ABSTRACT

An approach is provided for semantic categorization of arbitrarily granular locations. The approach, for instance, involves receiving a location subgraph specified at an arbitrary geographic granularity. The location subgraph, for instance, comprises multi-modal relational location data associated with one or more location entities. The approach also comprises processing the location subgraph using a machine learning model to predict a semantic category representing the location subgraph and/or the one or more location entities in the location subgraph. The approach further comprises providing the semantic category as an output.

### BACKGROUND

Mapping service providers have invested significant resources to maintain up-to-date and accurate mapping data. For example, service providers expend considerable effort to discover new and updated points of interest (POIs) or places (e.g., restaurants, stores, etc.) because of the relatively high rate of change for such places (e.g., as new places are established or existing places change). Then once new or updated places are discovered, service providers can classify the places or locations into respective categories (e.g., office buildings, restaurants, bars, etc.). However, these categories have historically been limited to discrete places or locations. In other words, the categories generally apply only to the specific place or location that has been classified. Accordingly, service providers face significant technical challenges with respect to categorizing places or locations that are arbitrarily defined (e.g., defined over any geographic extent without restriction to previously defined locations, administrative areas, borders, etc.) as opposed to being discretely defined (e.g., specific places, POIs, or other mapped features).

### SOME EXAMPLE EMBODIMENTS

Therefore, there is a need for providing semantic categorization of an arbitrarily granular location (e.g., a location that can be specified over any geographic extent, over any number or combination of locations/places/entities, etc.).

According to one embodiment, a method comprises receiving a location subgraph specified at an arbitrary geographic granularity (or any other input specifying one or more locations and associated context information at an arbitrary granularity). The location subgraph, for instance, comprises multi-modal relational location data associated with one or more location entities. The method also comprises processing the location subgraph using a machine learning model to predict a semantic category representing the location subgraph, the one or more location entities in the location subgraph, or a combination thereof. The method further comprises providing the semantic category as an output (e.g., provided to a targeted marketing service, a navigation routing service, a recommendation service, etc.).

According to another embodiment, an apparatus comprises at least one processor, and at least one memory including computer program code for one or more computer programs, the at least one memory and the computer program code configured to, with the at least one processor, cause, at least in part, the apparatus to receive a location subgraph specified at an arbitrary geographic granularity (or any other input specifying one or more locations and associated context information at an arbitrary granularity). The location subgraph, for instance, comprises multi-modal relational location data associated with one or more location entities. The apparatus is also caused to process the location subgraph using a machine learning model to predict a semantic category representing the location subgraph, the one or more location entities in the location subgraph, or a combination thereof. The apparatus is further caused to provide the semantic category as an output (e.g., provided to a targeted marketing service, a navigation routing service, a recommendation service, etc.).

According to another embodiment, a non-transitory computer-readable storage medium carries one or more sequences of one or more instructions which, when executed by one or more processors, cause, at least in part, an apparatus to receive a location subgraph specified at an arbitrary geographic granularity (or any other input specifying one or more locations and associated context information at an arbitrary granularity). The location subgraph, for instance, comprises multi-modal relational location data associated with one or more location entities. The apparatus is also caused to process the location subgraph using a machine learning model to predict a semantic category representing the location subgraph, the one or more location entities in the location subgraph, or a combination thereof. The apparatus is further caused to provide the semantic category as an output (e.g., provided to a targeted marketing service, a navigation routing service, a recommendation service, etc.).

According to another embodiment, an apparatus comprises means for receiving a location subgraph specified at an arbitrary geographic granularity (or any other input specifying one or more locations and associated context information at an arbitrary granularity). The location subgraph, for instance, comprises multi-modal relational location data associated with one or more location entities. The apparatus also comprises means for processing the location subgraph using a machine learning model to predict a semantic category representing the location subgraph, the one or more location entities in the location subgraph, or a combination thereof. The apparatus further comprises means for providing the semantic category as an output (e.g., provided to a targeted marketing service, a navigation routing service, a recommendation service, etc.).

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing semantic categorization of arbitrarily granular locations, according to one embodiment;

FIG. 2 is a diagram of components of a mapping platform capable of providing semantic categorization of arbitrarily granular locations, according to one embodiment;

FIG. 3 is a flowchart of a process for providing semantic categorization of arbitrarily granular locations, according to one embodiment;

FIG. 4 is a diagram illustrating an example of specifying an arbitrarily granular location subgraph for semantic categorization, according to one embodiment;

FIG. 5 is a diagram illustrating an example of using a mapping platform to provide semantic categorization of an arbitrarily granular location subgraph, according to one embodiment;

FIG. 6 is a diagram illustrating an example of encoding vectors for training a graph neural network, according to one embodiment;

FIG. 7 is a diagram illustrating an example of a read-out of an arbitrarily granular location subgraph for semantic categorization according to one embodiment;

FIG. 8 is a diagram illustrating an example mapping user interface for selecting an arbitrarily granular location for semantic categorization, according to one embodiment;

FIG. 9 is a diagram illustrating an example navigation user interface for presenting navigation routes generated based on semantic categorization of arbitrarily granular routes, according to one embodiment;

FIG. 10 is a diagram of a geographic database, according to one embodiment;

FIG. 11 is a diagram of hardware that can be used to implement an embodiment of the processes described herein;

FIG. 12 is a diagram of a chip set that can be used to implement an embodiment of the processes described herein; and

FIG. 13 is a diagram of a terminal that can be used to implement an embodiment of the processes described herein.

### DESCRIPTION OF SOME EMBODIMENTS

Examples of a method, apparatus, and computer program for providing semantic categorization of arbitrarily granular locations are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

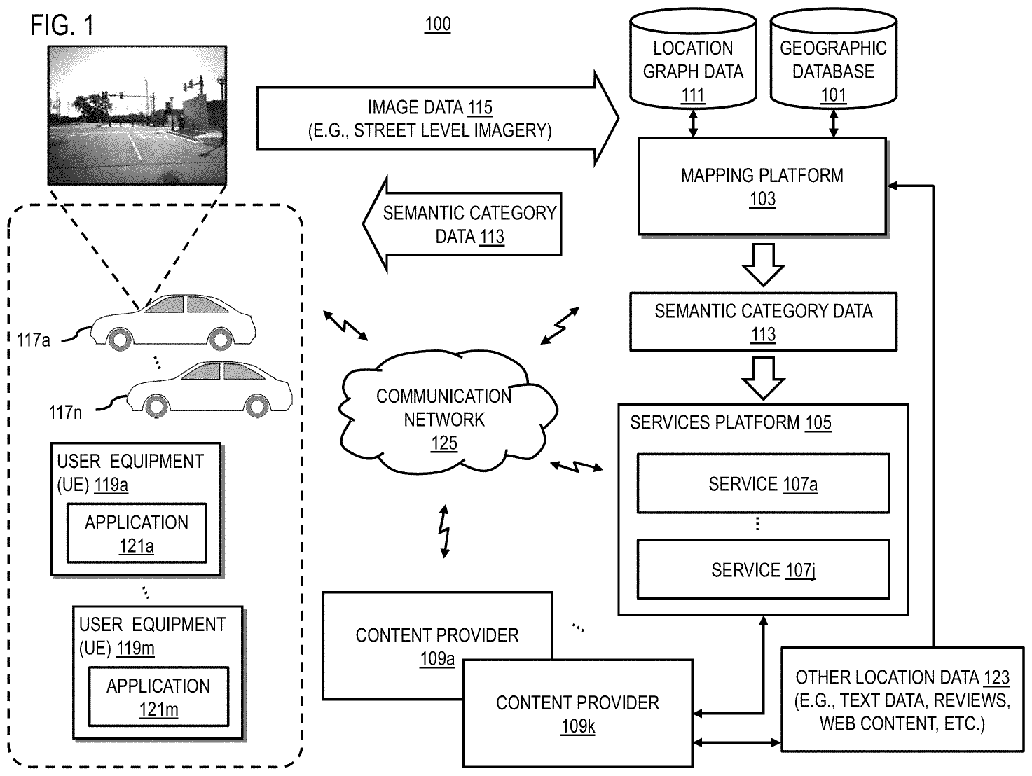

FIG. 1 is a diagram of a system capable of providing semantic categorization of arbitrarily granular locations, according to one embodiment. Generally, digital map data (e.g., the digital map data of a geographic database 101) store data on points-of-interest (POIs), locations, places, and/or any other map feature mapped from a corresponding geographic area. These map features can be referred to as location entities or objects that represent discrete locations or map features. A discrete location refers, for instance, to mapped entities with correspondingly defined geocoordinates to point locations and/or boundaries (e.g., political boundaries such as neighborhoods, streets, street segments, cities, countries, regions, etc.). Accordingly, any categories applied a discrete location historically has applied just to the corresponding point location and/or boundaries. In other words, in traditional digital maps, location categorization typically occurs at the lowest available level. For example, restaurants may be associated with a type of cuisine; cartography or map features may be typed as a park, beach, etc.; buildings may be typed as a bank, subway station, etc.

There are two main problems with this traditional categorization approach that present significant technical challenges to overcome:
1. Most categorization efforts are rule-based, relying on brittle heuristics that may not generalize well (e.g., an example heuristic may specify that “all cartography features near water are beaches”).
2. Atomic location categorization (e.g., applying labels to the smallest indivisible location) results in inconsistent granularity (e.g., a building may contain POIs, like stores in a mall, with each POI having their own respective categories) and is not flexible enough to handle changes in scope (e.g., categorizing a street or a neighborhood rather than individual POIs).

To address these technical challenges, the system 100 of FIG. 1 introduces a capability to classify locations of arbitrary granularity with one or more semantic categories, particularly when the semantic categories are higher order or more abstract semantic categories such as, but not limited to, “family friendly”, “trendy”, “artsy”, etc. Arbitrary granularity refers to specifying a location at a granularity (e.g., a geographic extent, number or combination of corresponding location entities, or a combination thereof) that is not restricted to the granularities provided by the geographic database 101 or other map data source (e.g., restricted to the lowest available level of granularity). For example, an arbitrarily granular location may refer to a geographic extent or area covering multiple location entities (e.g., multiple POIs, each with respective previously determined place categories). The system 100 can then determine and provide a semantic categorization for this arbitrarily granular location.

The various embodiments of the system 100 described herein draw on machine learning for classification, clustering, and topic modeling, along with the general insights available from the location-aware technologies and data of the various components of the system 100. By way of example, these components include but, are not limited to, a mapping platform 103, services platform 105, services 107a-107j (also collectively referred to as services 107) of the services platform 105, and content providers 109a-109k (also collectively referred to as content providers 109).

In one embodiment, given arbitrarily granular locations (e.g., specified as location graph data 111 or equivalent) and their contexts (e.g., multi-modal relational location data) as input, the system 100 is configured to predict semantic categories (e.g., semantic category data 113) for those locations. Multi-modal relational location data comprises any location data available in any media or mode that can be used to indicate spatial and/or semantic relationship information between one or more location entities, objects, or features included as part of an arbitrarily granular location. By way of example, the multi-modal relational location data can include, but is not limited to, the digital map data of the geographic database 101 and/or location graph data 111. Another example is image data 115 (e.g., street level imagery) captured by one or more imaging sensors of vehicles 117a-117n (also collectively referred to as vehicles 117), user equipment (UE) devices 119a-119m (also collectively referred to as UEs 119) executing respective imaging-capable or location-capable applications 121a-121m (also collectively referred to as applications 121), etc. In addition or alternatively, the services platform 105, services 107, and/or content providers 109 can provide multi-modal relational location data as other location data 123 such as, but not limited, text data extracted from online and/or external sources (e.g., online review data, web content crawling results, etc.).

The mapping platform 103 can include any of the multi-modal relational location data as internal data sources (e.g., data sources collected or managed by the mapping platform 103 itself such as, but not limited, to the geographic database 101 and/or location graph data 111). In addition or alternatively, the mapping platform 103 can access the multi-modal relational location data as external data sources (e.g., third party data sources) over a communication network 125. Examples of the external data sources include, but are not limited to, the image data 115 and/or other location data 123.

As used herein with respect to the various embodiments, the terms “location” and “semantic category” are intended to be broad. For example, “location” can refer to anything from an individual POI (or even a part of a POI such as a specific location within a POI—e.g., a floor within a building POI) to a larger administrative area like a street, neighborhood, city, etc. Similarly, “semantic category” could be equally expressive, encompassing categories such as, but not limited to, “family-friendly”, “safe for travelers”, “trendy”, “artsy”, etc. A semantic category can be, for instance, any label with encompassing location entities with at least one designated attribute that is similar to within a threshold similarity or that meets a threshold level for the attribute.

In summary, the various embodiments of the system 100 provides a generalizable approach to semantic categorization by enabling an input of any arbitrarily granular location, and then extracting features associated with the arbitrarily granular location. The system 100 then uses a machine learning approach to process the extracted features as an input to classify the arbitrarily granular location into one or more semantic categories.

A generalizable approach to predicting semantic categories for arbitrary locations can be a powerful improvement over traditional rule-based approaches and extends the system 100′s semantic categorization capability beyond the traditional ad-hoc, low-level categorization approach. More specifically, the semantic categorization approach of the various embodiments described herein extends the current state of categorizing beyond individual location entities (e.g. POIs, cartography/map features, buildings, etc.) to arbitrarily granular groups of location entities such as, but not limited to, neighborhoods, city blocks, parkways, etc. In addition, domain specific sematic categories can be assigned to these entries as a method of specialization based on use case. For example, in one embodiment, a delivery use case can have different sematic labels or categories than a consumer use case.

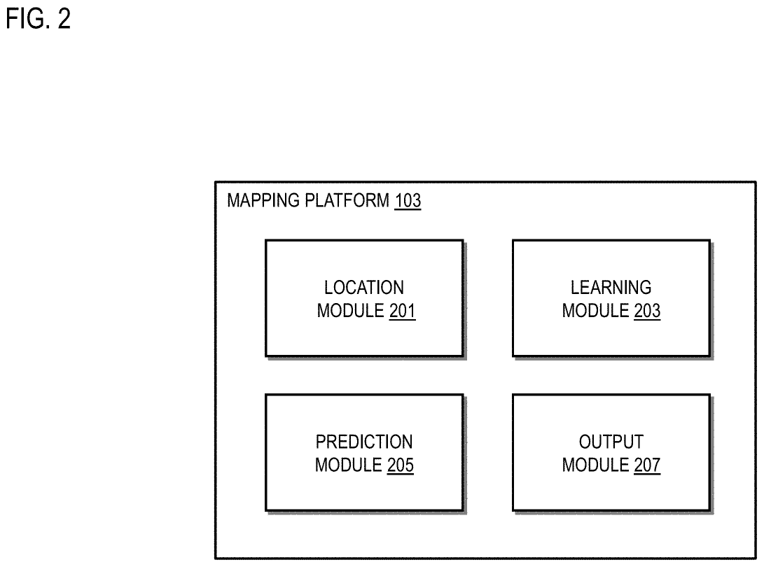

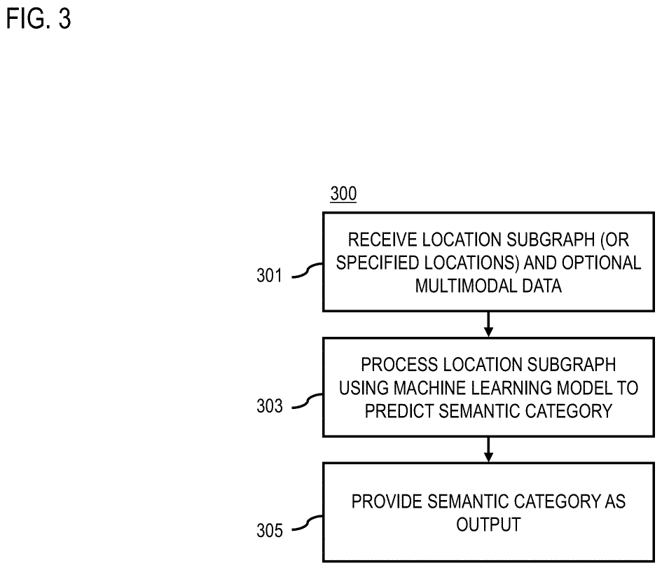

In one embodiment, as shown in FIG. 2, the mapping platform 103 of the system 100 includes one or more components for providing semantic categorization of arbitrarily granular locations according to the various embodiments described herein. It is contemplated that the functions of the components of the mapping platform 103 may be combined or performed by other components of equivalent functionality. As shown, in one embodiment, the mapping platform 103 includes a location module 201, a machine learning module 203, a prediction module 205, and an output module 207. The above presented modules and components of the mapping platform 103 can be implemented in hardware, firmware, software, or a combination thereof. Though depicted as a separate entity in FIG. 1, it is contemplated that the mapping platform 103 may be implemented as a module of any of the components of the system 100 (e.g., a component of the services platform 105, services 107, content providers 109, vehicles 117, UEs 119, and/or the like). In another embodiment, one or more of the modules 201-207 may be implemented as a cloud-based service, local service, native application, or combination thereof. The functions of the mapping platform 103 and modules 201-207 are discussed with respect to FIGS. 3-10 below.

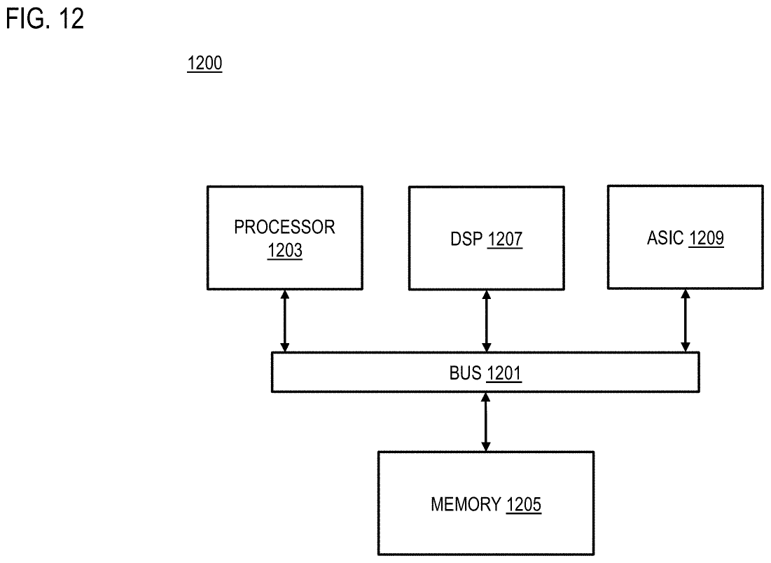

FIG. 3 is a flowchart of a process for providing semantic categorization of arbitrarily granular locations, according to one embodiment. In various embodiments, the mapping platform 103 and/or any of the modules 201-207 may perform one or more portions of the process 300 and may be implemented in, for instance, a chip set including a processor and a memory as shown in FIG. 12. As such, the data mapping platform 103 and/or any of the modules 201-207 can provide means for accomplishing various parts of the process 300, as well as means for accomplishing embodiments of other processes described herein in conjunction with other components of the system 100. Although the process 300 is illustrated and described as a sequence of steps, it is contemplated that various embodiments of the process 300 may be performed in any order or combination and need not include all of the illustrated steps.

In one embodiment, the process 300 relates to ingesting arbitrary location data (e.g., location graph entities, street-level imagery, text descriptions, etc.) and then outputting semantic categories for these locations. Accordingly, in step 301, the location module 201 receives an input specifying one or more locations and context association information associated with the one or more locations. The one or more locations are specified in the input at an arbitrary granularity.

In one embodiment, the location module 201 can receive the input as a location subgraph specified at an arbitrary geographic granularity. The location subgraph, for instance, comprises multi-modal relational location data associated with one or more location entities. By way of example, the location subgraph represents the one or more location entities as one or more nodes, and relationship information (e.g., spatial and/or semantic relationship) between the one or more location entities as one or more edges between the one or more nodes. These relationships or structural information may be spatial, temporal, or dynamic. Further semantic, descriptions such as, but not limited to, “nearby”, “across from”, “inside”, etc. can be used to describe spatial or semantic relationships between location objects wherein precise position is not known. In embodiments where the precise position is known (e.g., from the geographic database) the relationship ship in the location subgraph can be based on this precise positioning. These relationships may include attributes such as, but not limited to, distances, weight, text descriptions, binary objects, and/or the like.

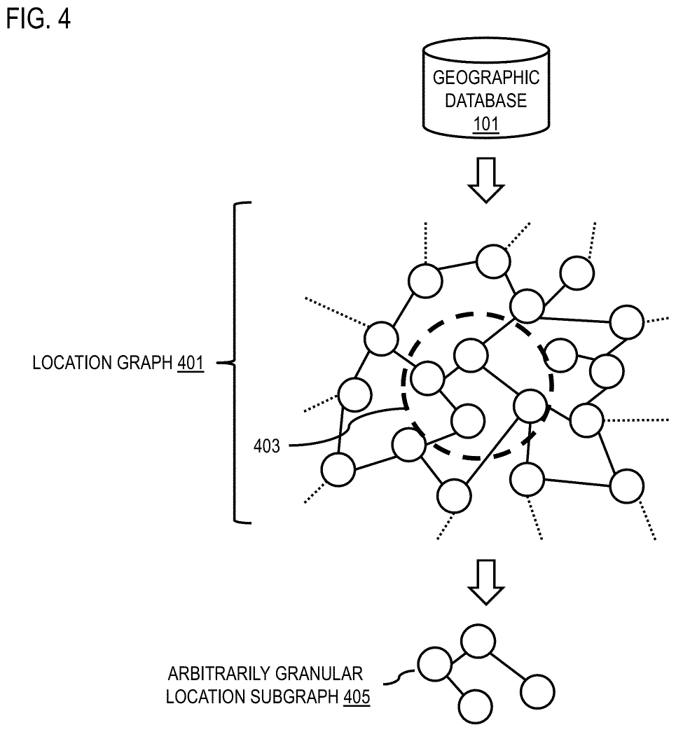

FIG. 4 is a diagram illustrating an example of specifying an arbitrarily granular location subgraph for semantic categorization, according to one embodiment. In the example of FIG. 4, the digital map data of the geographic database 101 can be processed to generate a location graph 401 of the location entities (e.g., POIs, places, terrain features, administrative areas, and/or any other stored cartography/map features) of the geographic database 101. The location graph 401, for instance, can represent all of the stored location entities of the geographic database 101 or just a portion of the geographic database 101 (e.g., location graph associated with a country, region, city, etc.). As previously discussed, the location graph 401 can model relationships between location entities or objects in a variety of ways. Location entities and their relationships may be described using a set of labels (e.g., entity categories such as restaurant, park, office building, etc.). Location entities or objects may be referred to as “nodes” of the location graph 401 (e.g., represented as circles in FIG. 4) and the “edges” (e.g., represented as lines between nodes in FIG. 4) represent relationships between nodes, where the nodes and relationships among nodes may have data attributes. The organization of the location graph may be defined by a data scheme which defines the structure of the data. The organization of the nodes and relationships may be stored in an ontology (e.g., in the location graph data 111 and/or the geographic database 101) which defines a set of concepts where the focus is on the meaning and shared understanding. These descriptions permit mapping of concepts from one domain to another.

In one embodiment, the data attributes associated with the nodes and/or edges of the location graph 401, may include multi-modal relational data. The multi-modal relational location data includes geographic location data, relative location data, place category data, imagery data, text data, context data, or a combination thereof associated with the one or more location entities, a geographic area in which the one or more entities are located, or a combination thereof. In one embodiment, the multi-model relational location data is retrieved from a third-party external semantic data source.

In other words, the location graph 401 is a knowledge graph of nodes that are interrelated with relationships between the different nodes. As previously described, in a location graph, the nodes are location entities or objects. For example, a node may be a POI such as a theater. Other nodes may include a first street, a second street, a parking lot, etc. Relationships may interconnect the nodes of the location graph 401, such as a relationship between the theater node and the first street may include a numerical address, where the numerical address is the relationship between the first street and the theater. A parking lot node may be affiliated with the theater node, and the relationship may be an indication of parking available for the theater. The relationship between the second street node and the theater node may include an entrance to the parking lot, such that the second street node is connected to the theater node by way of the parking lot node.

While example embodiments may include location entities as nodes, nodes may take many forms, including an event, for example. An event may be a node that includes a time (date/time), location, event type (e.g., sporting event), etc. That node may be related to the physical location of the event, transportation nodes, or other elements that have a contextual relationship with the event. The relationships or connections amongst the nodes of a location graph may be contextual links, whereby the relationships relate to how a node is connected to another node.

As shown in FIG. 4, a portion of the location graph 401 can be arbitrarily partitioned (e.g., partitioned based on the boundary 403 indicated by dashed circle) to create or otherwise designate an arbitrarily granular location subgraph 405. The location subgraph 405 is arbitrarily granular because the boundary 403 can be specified at any scale or size without restriction to any previous organization or grouping of the location entities in the location graph 401. It is noted the example of the boundary 403 being defined by a circle is provided by way of illustration and not as a limitation. It is contemplated that the boundary 403 may be defined using any shape or means.

In one embodiment, the location subgraph 405 can then be received for semantic categorization according to the embodiments described herein. In one embodiment, the location subgraph 405 can represent at least a part of a higher order location and wherein the one or more location entities in the location subgraph 405 include one or more descendent nodes of the higher order location. For example, a shopping mall may be a higher order node, and the descendent nodes of the shopping mall may include one or more stores located in the shopping mall. In another example, a higher order location can include a building and the descendent nodes can include one or more rooms in the building. It is further noted that although the location subgraph 405 is provided as an example input for specifying an arbitrarily granular location, it contemplated that any means for specifying an arbitrarily granular location may be used according to the embodiments described herein. For example, an arbitrary list of location entities, an arbitrarily granular area on a map, and/or the like can be provided as an input for semantic categorization.

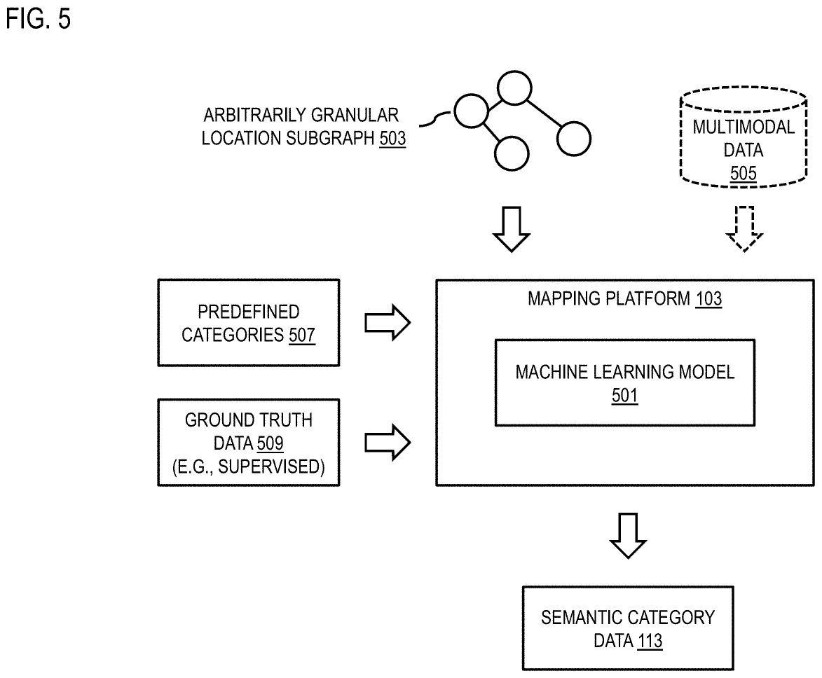

In step 303, prediction module 205 processes the arbitrarily granular location subgraph using a machine learning model to predict a semantic category representing the location subgraph, the one or more location entities in the location subgraph, or a combination thereof. This step is described in more detail with respect to FIG. 5 which is a diagram illustrating an example of using a mapping platform to provide semantic categorization of an arbitrarily granular location subgraph, according to one embodiment. As shown, the prediction module 205 can use a machine learning model 501 or equivalent predictive process of the mapping platform 103 to receive the arbitrarily granular location subgraph 503 (and/or multi-modal relational location data 505 associated with location entities and relationships between the location entities of the location subgraph 503). The machine learning model 501 can the predict the semantic category data 113 for the arbitrarily granular location subgraph 503 given the set of predefined semantic categories of interest 507, and optionally, ground truth data 509 that associates at least some of the predefined categories of interest 507 with location graphs/subgraphs and their spatial/semantic relationships (or other underlying learned structure). These inputs and outputs of the machine learning model 501 can be summarized as follows:
Given
   Predefined set of categories of interest 507
   (Optional; supervised learning approach only) Ground truth data 509 comprising associations between some categories and some locations
Input
   Arbitrarily granular location subgraph 503 and/or corresponding multimodal relational location data 505
Output
   Predictions for which semantic categories (e.g., semantic category data 113) correspond to the input arbitrarily granular location subgraph 503 and/or multimodal relational location data 505

In one embodiment, the prediction module 205 has access to arbitrary quantities of location data (e.g., from the geographic database 101, location graph data 111, services platform 105, services 107, and/or content providers 109). Accordingly, the prediction module 205 could ostensibly use everything available as features representing the input arbitrarily granular location subgraph 503 in the machine learning predictive process. For example, the prediction module 205 can leverage the available location data to determine features such as, but not limited to, “whether there's a park within X meters” to “business density” and so on.

In one embodiment, the prediction module 205 can classify arbitrarily granular location subgraphs (e.g., from in the larger location graph) which correspond to a higher order location (e.g., all the descendent nodes from a District, for example, would essentially define that District). In classifying arbitrarily granular subgraphs, the machine learning model 501, for instance, would learn the structural elements in higher order locations that help define a given semantic category. In other words, the machine learning model 501 learns one or more structural elements of the higher order location, and wherein the semantic category is predicted based at least in part on the one or more structural elements. The one or more structural elements represents a spatial relationship, a semantic relationship, or a combination thereof among the one or more of location entities of the location subgraph.

It is contemplated that any machine learning approach may be applied to the various embodiments semantic categorization task described herein. Example approaches to this task include, but is not limited to, supervised (e.g., the learning module 203 has some categorized locations—e.g., ground truth data 509—on which the machine learning model 501 can be trained) and unsupervised (e.g., the learning module 203 may want to cluster the input location data with the understanding that certain semantic categories may emerge). In other words, the machine learning model 501 can be trained (e.g., by the learning module 203) using a supervised learning approach on an association between (1) a plurality of ground truth categories of the predefined site of categories of interest, and (2) a plurality of ground truth location entities. In addition or alternatively, the learning module 203 can use an unsupervised learning approach on the machine learning model 501 to cluster multi-modal relational location data to determine the semantic category(ies), the predefined set of categories of interest 507 from which the semantic category (e.g., the sematic category data 113) is predicted, or a combination thereof

It is contemplated that the machine learning model 501 can be any type of model including, but not limited to, neural networks, support vector machines (SVM), decision trees, etc. In one embodiment, the machine learning model 501 can be based on a graph neural network to classify nodes (e.g., low-level locations like POIs) and subgraphs (e.g., higher-level locations like neighborhoods) according to the various embodiments described herein. A graph neural network, for instance, encodes one or more structural elements of the location graph/subgraph as one or more layers of the graph neural network during training.

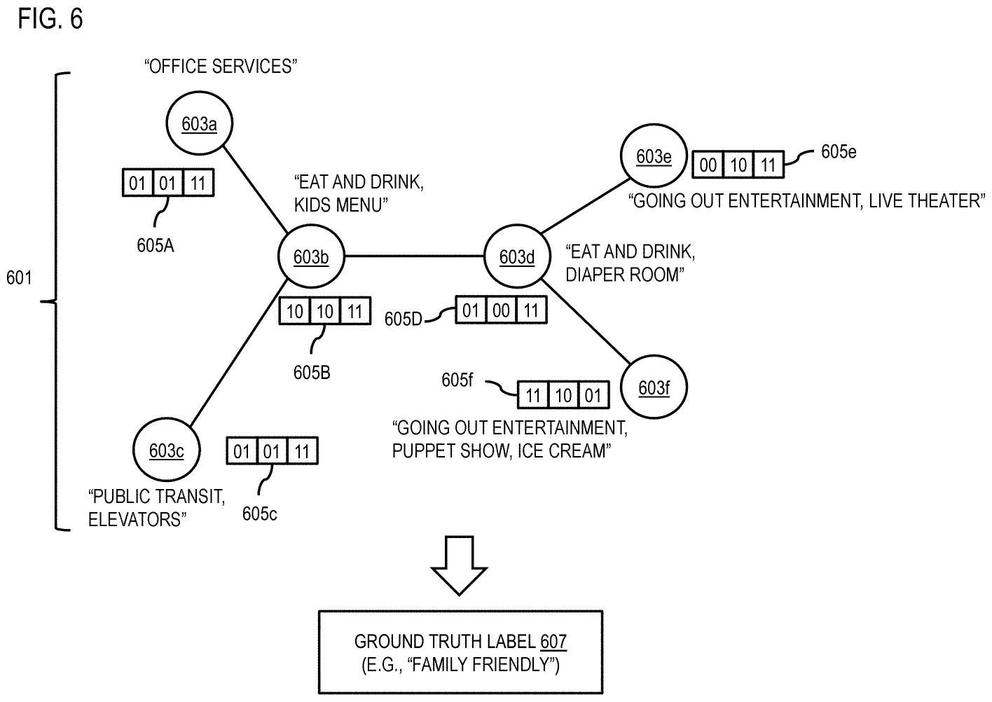

In one embodiment, the graph neural network encodes each node of graph to contain its own information (e.g., multi-modal relational location data in vector form or equivalent). In particular, the encoded information contains information (e.g., place name, geo-coordinates, place category information) of each node itself, together with its neighboring nodes information. FIG. 6 is a diagram illustrating an example of encoding vectors for training a graph neural network, according to one embodiment. The example of FIG. 6 illustrates a location graph 601 comprising nodes 603a-603f (also collectively referred to as nodes 603) along with the relationship information about the nodes 603 indicated by respective edges or connections between the nodes. In this example, each of the nodes 603a-603f is associated with respective place category information that is encoded to respective encoding vectors 605a-605f (also collectively referred to as encoding vectors 605). For example, the place categories of each node 603 is encoded as a sequence of two digit binary numbers corresponding to a presence or absence of a training feature of interest. The location graph 601 is further associated with a ground truth label 607 that indicates the ground truth semantic category (e.g., “family friendly”) for the location graph 601. This means that for the give group of locations represented in a location graph 601, a human annotator has marked the location graph 601 as a whole as being a family friendly location. For example, the location graph 601 represents an arbitrarily granular location on a street, the street location would be categorized as “friendly family.”

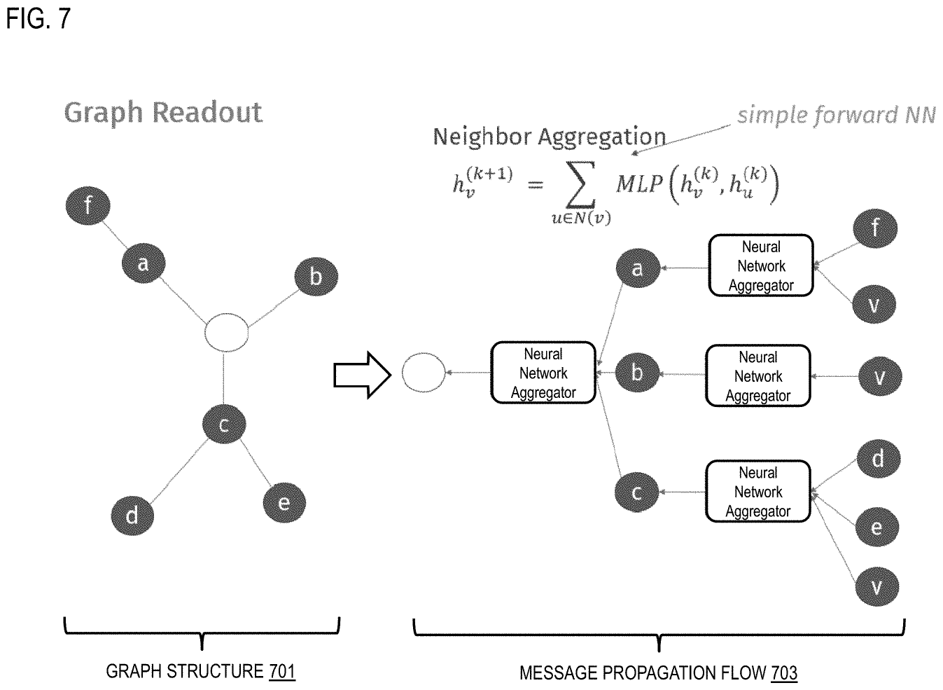

This training instance (along with other training instances) can be used to train the graph neural network to learning structural elements (e.g., spatial and/or semantic relationships between nodes in a location graph) that would lead to a prediction of a semantic category for arbitrarily granular locations. FIG. 7 is a diagram illustrating an example of a read-out of an arbitrarily granular location subgraph for semantic categorization according to one embodiment. In the graph neural network (e.g., a graph convolutional network) training stage, a message propagation method does the encoding task for all nodes (e.g., the location nodes 603 of the FIG. 6). FIG. 7 illustrates how a message from one node of a location graph can be propagated to adjacent connected nodes when encoded in a graph neural network according to the embodiments described herein. As shown, a graph structure 701 (e.g., comprising multi-modal relational location data for nodes a-f) represents a ground truth training instance.

In one embodiment, the graph structure 701 can be read out to a graph neural network structure where the location nodes are arranged in network layers corresponding the adjacency of the nodes in the graph structure 701. The message propagation flow 703 indicates how messages flow through the layers of the graph neural network. The message propagation flow 703 illustrates the output node on the left side (e.g., indicated by a white circle) which is feed messages from nodes a, b, and c through a neural network aggregator (e.g., neighbor aggregation through simple feed forward neural network aggregation). Each of the immediate neighbor a, b, and c respectively receive aggregated messages from their respective neighbors.

Under a supervised learning approach, the message propagation flow 703 results in a semantic categorization output that is then compared to the ground truth semantic label associated with the graph structure 701. This prediction is made with an initial set of weights and coefficients of the graph neural network. These weights and coefficients can then be varied until the predictive result matches the ground truth data with a target level of accuracy. At this point, the graph neural network can be considered “trained” and ready to predict semantic categories for arbitrarily granular location inputs. Under an unsupervised learning approach, the message propagation flow 703 results in an emergent semantic category or categories that are discovered using clustering and/or any other equivalent unsupervised learning approach.

After the location subgraph received in step 301 is encoded to an input vector, the input vector is fed into the trained machine learning model to predict a semantic category for the arbitrarily granular location subgraph. The predicted semantic category can be the one or more categories that have the highest classification probability or that have classification probabilities above a threshold value.

In step 305, the output module 207 provides the predicted semantic category or categories as an output. For example, the output can provided to a targeted marketing service (such as for advertising or an advertising service), a navigation routing service, a recommendation service, and/or any other service that can use semantic categorization of arbitrarily granular locations (e.g., the services platform 105 and/or services 107).

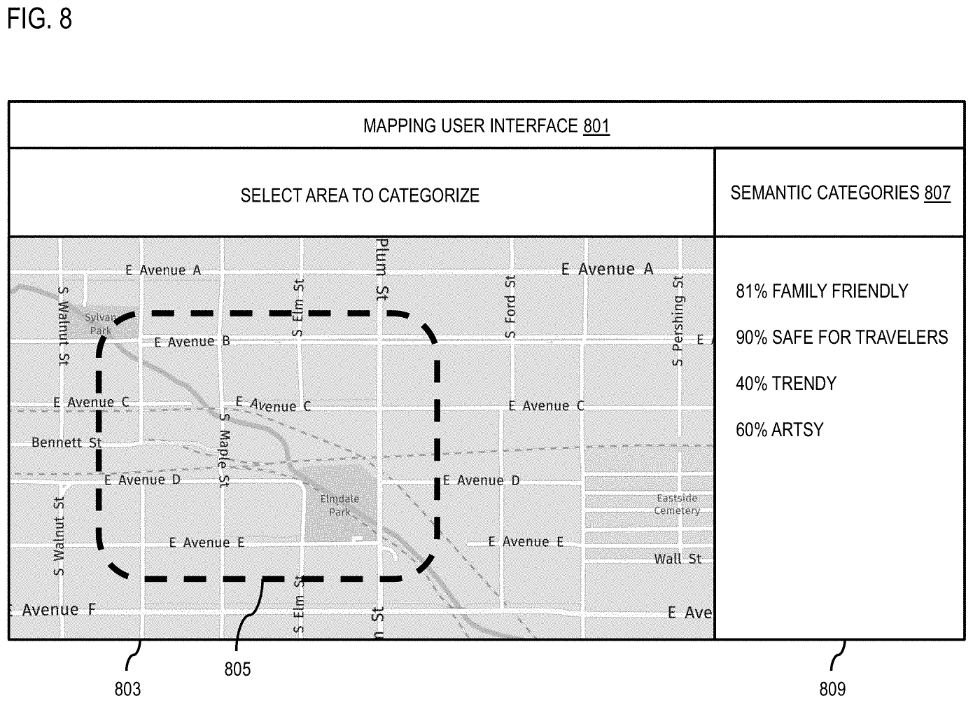

FIG. 8 is a diagram illustrating an example mapping user interface for selecting an arbitrarily granular location for semantic categorization, according to one embodiment. In the example of FIG. 8, a user (e.g., marketing executive) interacts with a mapping user interface 801 to select an arbitrarily granular area to request semantic. For example, in user interface element 803, the user selects an arbitrarily granular location by drawing a rectangular shape 805 to define the arbitrarily granular location. In response to the selection, the mapping platform 103 performs a spatial query of the location graph data 111 for a location subgraph corresponding to the geographic area defined by the rectangular shape 805. The multi-modal relational location data associated with the determined location subgraph is processed to generate an input feature to machine learning model trained for semantic category prediction according to the embodiments described herein. The machine learning model outputs a list of predicted categories and associated classification probabilities. The predicted semantic categories 807 and classification probabilities are then presented in the user interface 801 at user interface element 809.

In one scenario, the user can be a marketing executive attempting to understand the semantic categories of an arbitrarily granular location in which the user's company plans to market “family friendly” products. Because the selected area has a relatively high (e.g., 81%) classification probability for the “family friendly” category, the corresponding area may be a suitable target area for the user. The mapping user interface 801 also enables the user to adjust the selected areas to see the effect on the resulting semantic category prediction (e.g., extending the area in one direction can raise or lower the classification probability of the “family friendly” category or the emergence of other semantic categories.

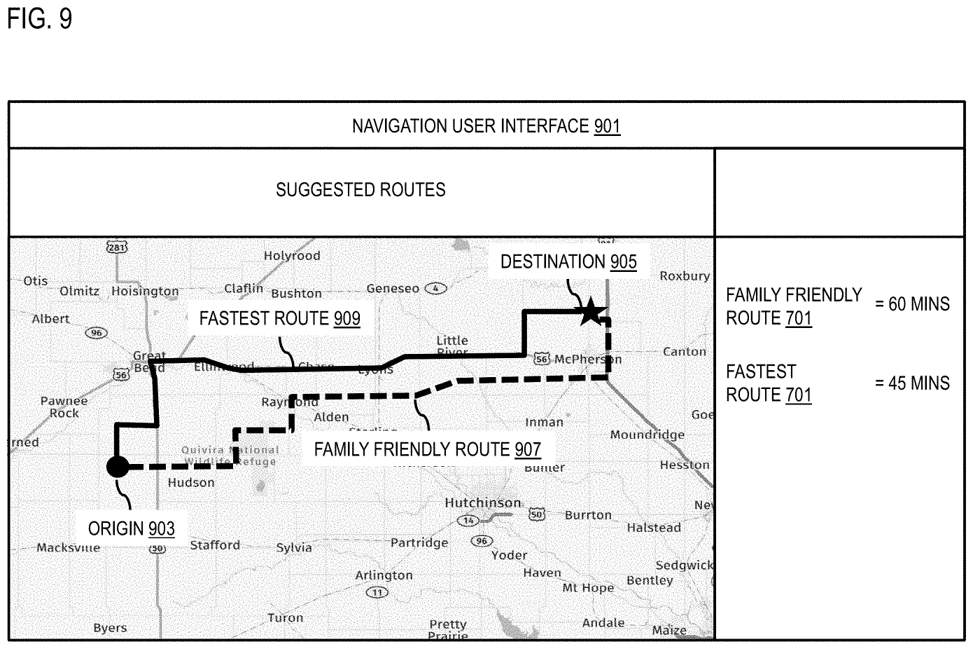

FIG. 9 is a diagram illustrating an example navigation user interface for presenting navigation routes generated based on semantic categorization of arbitrarily granular routes, according to one embodiment. In the example of FIG. 9, a user interacts with the navigation user interface 901 to specify an origin 903 and destination 905 for a planned trip. The user has requested both a “family friendly” route, for instance, on which more family friendly locations are located (e.g., have locations that provide for family related services such as family appropriate food, family entertainment stops, etc.). In response, the mapping platform 103 computes possible candidate routes (e.g., using any routing algorithm known in the art). The mapping platform 103 can then create respective arbitrarily granular location graphs covering the route and threshold proximity corridor around the routes. The mapping platform 103 can then predict the semantic categories for each route's location subgraph and then select the route (e.g., family friendly route 907) with the highest classification probability for the “family friendly” semantic category. In this example, the mapping platform 103 also calculates the fastest route 909 for comparison against the family friendly route 907. Both routes 907 and 909 can be presented in the user interface 901 along with calculated trip durations for selection by the user.

It is noted that the example uses of the semantic categorization of arbitrarily granular locations described above are provided by way of illustration and not as limitation. It is contemplated that the semantic categorization can be used for any service, application, or function that can receive the semantic category data 113.

Returning to FIG. 1, as shown, the system 100 includes a mapping platform 103 for providing semantic categorization of arbitrarily granular locations according to the various embodiments described herein. In one embodiment, the mapping platform 103 includes or is otherwise associated with one or more machine learning models (e.g., neural networks such as a graph neural network or other equivalent network) for predicting semantic categories. The machine learning models can also be used as part of a computer vision system for detecting new or updated places through image analysis.

In one embodiment, the mapping platform 103 has connectivity over the communication network 125 to the services platform 105 that provides one or more services 107 that can use semantic category data 113 (e.g., semantic category predictions) to perform one or more functions. By way of example, the services 107 may be third party services and include but is not limited to mapping services, navigation services, travel planning services, notification services, social networking services, content (e.g., audio, video, images, etc.) provisioning services, application services, storage services, contextual information determination services, location based services, information based services (e.g., weather, news, etc.), etc. In one embodiment, the services 107 uses the output of the mapping platform 103 (e.g., semantic category predictions) to provide services 107 such as navigation, mapping, other location-based services, etc. to the vehicles 117, UEs 119, and/or applications 121 executing on the UEs 119.

In one embodiment, the mapping platform 103 may be a platform with multiple interconnected components. The mapping platform 103 may include multiple servers, intelligent networking devices, computing devices, components, and corresponding software for providing semantic category prediction according to the various embodiments described herein. In addition, it is noted that the mapping platform 103 may be a separate entity of the system 100, a part of the one or more services 107, a part of the services platform 105, or included within components of the vehicles 117 and/or UEs 119.

In one embodiment, content providers 109 may provide content or data (e.g., including geographic data, semantic category data 113, etc.) to the geographic database 101, the mapping platform 103, the services platform 105, the services 107, the vehicles 117, the UEs 119, and/or the applications 121 executing on the UEs 119. The content provided may be any type of content, such as machine learning models, semantic category data 113, map embeddings, map content, textual content, audio content, video content, image content, etc. In one embodiment, the content providers 109 may provide content that may aid in performing semantic category prediction according to the various embodiments described herein. In one embodiment, the content providers 109 may also store content associated with the geographic database 101, mapping platform 103, services platform 105, services 107, and/or any other component of the system 100. In another embodiment, the content providers 109 may manage access to a central repository of data, and offer a consistent, standard interface to data, such as a repository of the geographic database 101.

In one embodiment, the vehicles 117 and/or UEs 119 may execute software applications 121 to detect map features/objects and/or make map-related predictions (e.g., semantic category prediction) according the embodiments described herein. By way of example, the applications 121 may also be any type of application that is executable on the vehicles 117 and/or UEs 119, such as autonomous driving applications, mapping applications, location-based service applications, navigation applications, device control applications, content provisioning services, camera/imaging application, media player applications, social networking applications, calendar applications, and the like. In one embodiment, the applications 121 may act as a client for the mapping platform 103 and perform one or more functions associated with providing semantic category prediction alone or in combination with the mapping platform 103.

By way of example, the vehicles 117 and/or UEs 119 is or can include any type of embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the vehicles 117 and/or UEs 119 can support any type of interface to the user (such as “wearable” circuitry, etc.). In one embodiment, the vehicles 117 and/or UEs 119 may be associated with or be a component of a vehicle or any other device.

In one embodiment, the vehicles 117 and/or UEs 119 are configured with various sensors for generating or collecting environmental image data (e.g., for processing by the mapping platform 103), related geographic data, etc. In one embodiment, the sensed data represent sensor data associated with a geographic location or coordinates at which the sensor data was collected, and the polyline or polygonal representations of detected objects of interest derived therefrom. By way of example, the sensors may include a global positioning sensor for gathering location data (e.g., GPS), IMUs, a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data (e.g., the camera sensors may automatically capture road sign information, images of road obstructions, etc. for analysis), an audio recorder for gathering audio data, velocity sensors mounted on steering wheels of the vehicles, switch sensors for determining whether one or more vehicle switches are engaged, and the like.

Other examples of sensors of the vehicles 117 and/or UEs 119 may include light sensors, orientation sensors augmented with height sensors and acceleration sensor, tilt sensors to detect the degree of incline or decline (e.g., slope) along a path of travel, moisture sensors, pressure sensors, etc. In a further example embodiment, sensors about the perimeter of the vehicles 117 and/or UEs 119 may detect the relative distance of the device or vehicle from a lane or roadway, the presence of other vehicles, pedestrians, traffic lights, potholes and any other objects, or a combination thereof. In one scenario, the sensors may detect weather data, traffic information, or a combination thereof. In one embodiment, the vehicles 117 and/or UEs 119 may include GPS or other satellite-based receivers to obtain geographic coordinates from positioning satellites for determining current location and time. Further, the location can be determined by visual odometry, triangulation systems such as A-GPS, Cell of Origin, or other location extrapolation technologies.

In one embodiment, the communication network 125 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., worldwide interoperability for microwave access (WiMAX), Long Term Evolution (LTE) networks, 5G New Radio networks, code division multiple access (CDMA), wideband code division multiple access (WCDMA), wireless fidelity (Wi-Fi), wireless LAN (WLAN), Bluetooth® network, Internet Protocol (IP) data casting, satellite, mobile ad-hoc network (MANET), and the like, or any combination thereof.

By way of example, the mapping platform 103, services platform 105, services 107, vehicles 117 and/or UEs 119, and/or content providers 109 communicate with each other and other components of the system 100 using well known, new or still developing protocols. In this context, a protocol includes a set of rules defining how the network nodes within the communication network 125 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

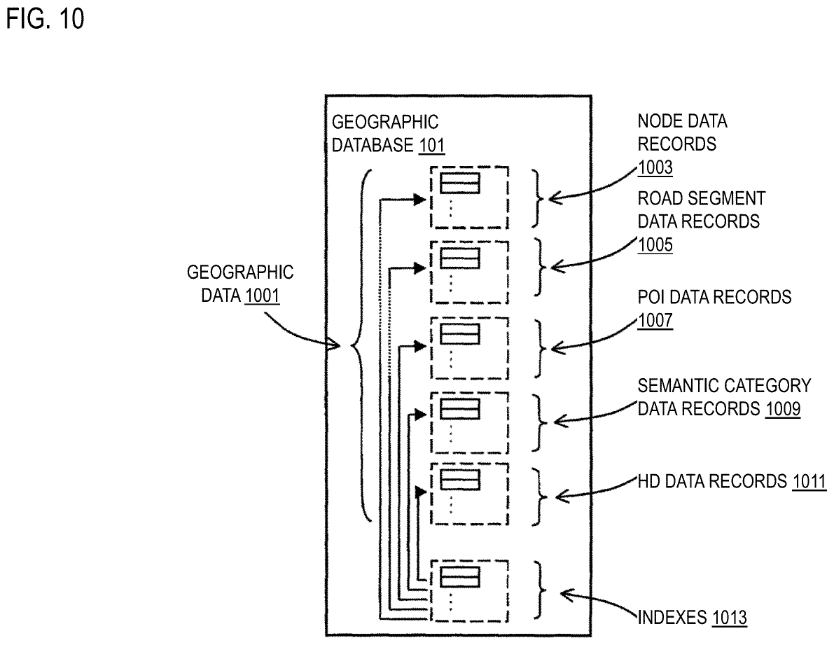

FIG. 10 is a diagram of a geographic database, according to one embodiment. In one embodiment, the geographic database 101 includes geographic data 1001 used for (or configured to be compiled to be used for) mapping and/or navigation-related services, such as for providing map embedding analytics according to the embodiments described herein. For example, the map data records stored herein can be used to determine the semantic relationships among the map features, attributes, categories, etc. represented in the geographic data 1001. In one embodiment, the geographic database 101 include high definition (HD) mapping data that provide centimeter-level or better accuracy of map features. For example, the geographic database 101 can be based on Light Detection and Ranging (LiDAR) or equivalent technology to collect billions of 3D points and model road surfaces and other map features down to the number lanes and their widths. In one embodiment, the HD mapping data (e.g., HD data records 1011) capture and store details such as the slope and curvature of the road, lane markings, roadside objects such as sign posts, including what the signage denotes. By way of example, the HD mapping data enable highly automated vehicles to precisely localize themselves on the road.

In one embodiment, geographic features (e.g., two-dimensional or three-dimensional features) are represented using polylines and/or polygons (e.g., two-dimensional features) or polygon extrusions (e.g., three-dimensional features). In one embodiment, these polylines/polygons can also represent ground truth or reference features or objects (e.g., signs, road markings, lane lines, landmarks, etc.) used for visual odometry. For example, the polylines or polygons can correspond to the boundaries or edges of the respective geographic features. In the case of a building, a two-dimensional polygon can be used to represent a footprint of the building, and a three-dimensional polygon extrusion can be used to represent the three-dimensional surfaces of the building. Accordingly, the terms polygons and polygon extrusions as used herein can be used interchangeably.

In one embodiment, the following terminology applies to the representation of geographic features in the geographic database 101.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 101 follows certain conventions. For example, links do not cross themselves and do not cross each other except at a node. Also, there are no duplicated shape points, nodes, or links. Two links that connect each other have a common node. In the geographic database 101, overlapping geographic features are represented by overlapping polygons. When polygons overlap, the boundary of one polygon crosses the boundary of the other polygon. In the geographic database 101, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 101 includes node data records 1003, road segment or link data records 1005, POI data records 1007, semantic category data records 1009, HD mapping data records 1011, and indexes 1013, for example. More, fewer or different data records can be provided. In one embodiment, additional data records (not shown) can include cartographic (“cartel”) data records, routing data, and maneuver data. In one embodiment, the indexes 1013 may improve the speed of data retrieval operations in the geographic database 101. In one embodiment, the indexes 1013 may be used to quickly locate data without having to search every row in the geographic database 101 every time it is accessed. For example, in one embodiment, the indexes 1013 can be a spatial index of the polygon points associated with stored feature polygons.

In exemplary embodiments, the road segment data records 1005 are links or segments representing roads, streets, or paths, as can be used in the calculated route or recorded route information for determination of one or more personalized routes. The node data records 1003 are end points (for example, representing intersections or an end of a road) corresponding to the respective links or segments of the road segment data records 1005. The road link data records 1005 and the node data records 1003 represent a road network, such as used by vehicles, cars, and/or other entities. Alternatively, the geographic database 101 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 101 can include data about the POIs and their respective locations in the POI data records 1007. The geographic database 101 can also include data about places, such as cities, towns, or other communities, and other geographic features, such as bodies of water, mountain ranges, etc. Such place or feature data can be part of the POI data records 1007 or can be associated with POIs or POI data records 1007 (such as a data point used for displaying or representing a position of a city).

In one embodiment, the geographic database 101 can also include semantic category data records 1009 for storing semantic category predictions, location graphs, machine learning model parameters, and/or any other related data that is used or generated according to the embodiments described herein. By way of example, the semantic category data records 1009 can be associated with one or more of the node records 1003, road segment records 1005, and/or POI data records 1007 to associate the semantic category predictions with specific places, POIs, geographic areas, and/or other map features. In this way, the semantic category data records 1009 can also be associated with the characteristics or metadata of the corresponding records 1003, 1005, and/or 1007.

In one embodiment, as discussed above, the HD mapping data records 1011 model road surfaces and other map features to centimeter-level or better accuracy. The HD mapping data records 1011 also include ground truth object models that provide the precise object geometry with polylines or polygonal boundaries, as well as rich attributes of the models. These rich attributes include, but are not limited to, object type, object location, lane traversal information, lane types, lane marking types, lane level speed limit information, and/or the like. In one embodiment, the HD mapping data records 1011 are divided into spatial partitions of varying sizes to provide HD mapping data to end user devices with near real-time speed without overloading the available resources of the devices (e.g., computational, memory, bandwidth, etc. resources).

In one embodiment, the HD mapping data records 1011 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the HD mapping data records 1011.

In one embodiment, the HD mapping data records 1011 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time data (e.g., including probe trajectories) also at centimeter-level accuracy. Other sensor data can include vehicle telemetry or operational data such as windshield wiper activation state, braking state, steering angle, accelerator position, and/or the like.

In one embodiment, the geographic database 101 can be maintained by the content provider 109 in association with the services platform 105 (e.g., a map developer). The map developer can collect geographic data to generate and enhance the geographic database 101. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The geographic database 101 can be a master geographic database stored in a format that facilitates updating, maintenance, and development. For example, the master geographic database or data in the master geographic database can be in an Oracle spatial format or other format (e.g., that can accommodate different/multiple map layers), such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF)) to organize and/or configure the data for performing navigation-related functions and/or services, such as route calculation, route guidance, map display, speed calculation, distance and travel time functions, and other functions, by a navigation device, such as by a vehicles 117 and/or UEs 119. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for providing semantic category prediction may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

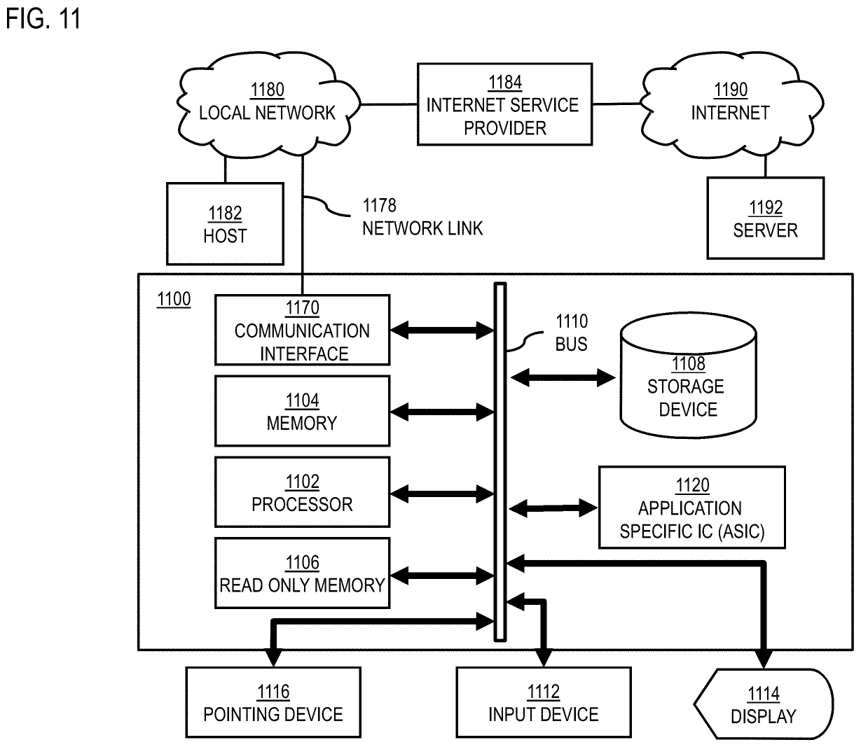

FIG. 11 illustrates a computer system 1100 upon which an embodiment of the invention may be implemented. Computer system 1100 is programmed (e.g., via computer program code or instructions) to provide semantic category prediction as described herein and includes a communication mechanism such as a bus 1110 for passing information between other internal and external components of the computer system 1100. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 1110 includes one or more parallel conductors of information so that information is transferred quickly among devices coupled to the bus 1110. One or more processors 1102 for processing information are coupled with the bus 1110.

A processor 1102 performs a set of operations on information as specified by computer program code related to providing semantic category prediction. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1110 and placing information on the bus 1110. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1102, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1100 also includes a memory 1104 coupled to bus 1110. The memory 1104, such as a random access memory (RANI) or other dynamic storage device, stores information including processor instructions for providing semantic category prediction. Dynamic memory allows information stored therein to be changed by the computer system 1100. RAM allows a unit of information stored at a location called a memory address to be stored and retrieved independently of information at neighboring addresses. The memory 1104 is also used by the processor 1102 to store temporary values during execution of processor instructions. The computer system 1100 also includes a read only memory (ROM) 1106 or other static storage device coupled to the bus 1110 for storing static information, including instructions, that is not changed by the computer system 1100. Some memory is composed of volatile storage that loses the information stored thereon when power is lost. Also coupled to bus 1110 is a non-volatile (persistent) storage device 1108, such as a magnetic disk, optical disk or flash card, for storing information, including instructions, that persists even when the computer system 1100 is turned off or otherwise loses power.

Information, including instructions for providing semantic category prediction, is provided to the bus 1110 for use by the processor from an external input device 1112, such as a keyboard containing alphanumeric keys operated by a human user, or a sensor. A sensor detects conditions in its vicinity and transforms those detections into physical expression compatible with the measurable phenomenon used to represent information in computer system 1100. Other external devices coupled to bus 1110, used primarily for interacting with humans, include a display device 1114, such as a cathode ray tube (CRT) or a liquid crystal display (LCD), or plasma screen or printer for presenting text or images, and a pointing device 1116, such as a mouse or a trackball or cursor direction keys, or motion sensor, for controlling a position of a small cursor image presented on the display 1114 and issuing commands associated with graphical elements presented on the display 1114. In some embodiments, for example, in embodiments in which the computer system 1100 performs all functions automatically without human input, one or more of external input device 1112, display device 1114 and pointing device 1116 is omitted.

In the illustrated embodiment, special purpose hardware, such as an application specific integrated circuit (ASIC) 1120, is coupled to bus 1110. The special purpose hardware is configured to perform operations not performed by processor 1102 quickly enough for special purposes. Examples of application specific ICs include graphics accelerator cards for generating images for display 1114, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1100 also includes one or more instances of a communications interface 1170 coupled to bus 1110. Communication interface 1170 provides a one-way or two-way communication coupling to a variety of external devices that operate with their own processors, such as printers, scanners, and external disks. In general, the coupling is with a network link 1178 that is connected to a local network 1180 to which a variety of external devices with their own processors are connected. For example, communication interface 1170 may be a parallel port or a serial port or a universal serial bus (USB) port on a personal computer. In some embodiments, communications interface 1170 is an integrated services digital network (ISDN) card or a digital subscriber line (DSL) card or a telephone modem that provides an information communication connection to a corresponding type of telephone line. In some embodiments, a communication interface 1170 is a cable modem that converts signals on bus 1110 into signals for a communication connection over a coaxial cable or into optical signals for a communication connection over a fiber optic cable. As another example, communications interface 1170 may be a local area network (LAN) card to provide a data communication connection to a compatible LAN, such as Ethernet. Wireless links may also be implemented. For wireless links, the communications interface 1170 sends or receives or both sends and receives electrical, acoustic, or electromagnetic signals, including infrared and optical signals, that carry information streams, such as digital data. For example, in wireless handheld devices, such as mobile telephones like cell phones, the communications interface 1170 includes a radio band electromagnetic transmitter and receiver called a radio transceiver. In certain embodiments, the communications interface 1170 enables connection to the communication network 125 for providing semantic category prediction.

The term computer-readable medium is used herein to refer to any medium that participates in providing information to processor 1102, including instructions for execution. Such a medium may take many forms, including, but not limited to, non-volatile media, volatile media, and transmission media. Non-volatile media include, for example, optical or magnetic disks, such as storage device 1108. Volatile media include, for example, dynamic memory 1104. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization, or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 1178 typically provides information communication using transmission media through one or more networks to other devices that use or process the information. For example, network link 1178 may provide a connection through local network 1180 to a host computer 1182 or to equipment 1184 operated by an Internet Service Provider (ISP). ISP equipment 1184 in turn provides data communication services through the public, world-wide packet-switching communication network of networks now commonly referred to as the Internet 1190.

A computer called a server host 1192 connected to the Internet hosts a process that provides a service in response to information received over the Internet. For example, server host 1192 hosts a process that provides information representing video data for presentation at display 1114. It is contemplated that the components of system can be deployed in various configurations within other computer systems, e.g., host 1182 and server 1192.

FIG. 12 illustrates a chip set 1200 upon which an embodiment of the invention may be implemented. Chip set 1200 is programmed to provide semantic category prediction as described herein and includes, for instance, the processor and memory components described with respect to FIG. 11 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1200 includes a communication mechanism such as a bus 1201 for passing information among the components of the chip set 1200. A processor 1203 has connectivity to the bus 1201 to execute instructions and process information stored in, for example, a memory 1205. The processor 1203 may include one or more processing cores with each core configured to perform independently. A multi-core processor enables multiprocessing within a single physical package. Examples of a multi-core processor include two, four, eight, or greater numbers of processing cores. Alternatively or in addition, the processor 1203 may include one or more microprocessors configured in tandem via the bus 1201 to enable independent execution of instructions, pipelining, and multithreading. The processor 1203 may also be accompanied with one or more specialized components to perform certain processing functions and tasks such as one or more digital signal processors (DSP) 1207, or one or more application-specific integrated circuits (ASIC) 1209. A DSP 1207 typically is configured to process real-world signals (e.g., sound) in real time independently of the processor 1203. Similarly, an ASIC 1209 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1203 and accompanying components have connectivity to the memory 1205 via the bus 1201. The memory 1205 includes both dynamic memory (e.g., RAM, magnetic disk, writable optical disk, etc.) and static memory (e.g., ROM, CD-ROM, etc.) for storing executable instructions that when executed perform the inventive steps described herein to provide semantic category prediction. The memory 1205 also stores the data associated with or generated by the execution of the inventive steps.

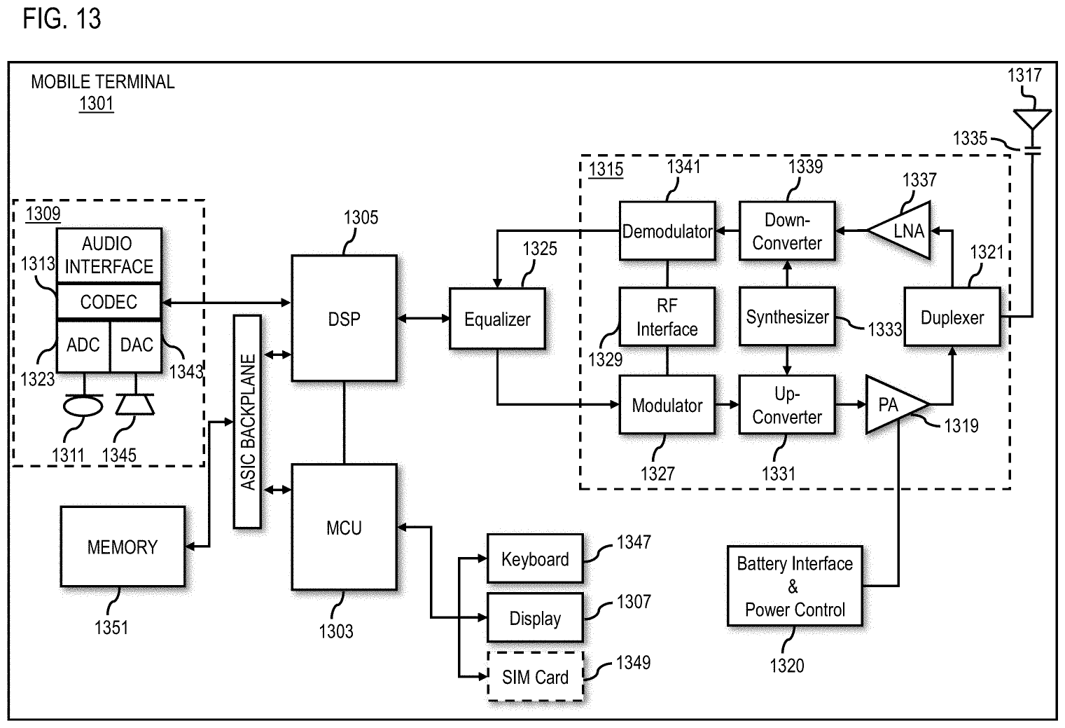

FIG. 13 is a diagram of exemplary components of a mobile terminal 1301 (e.g., a vehicle 117 and/or UE 119 or component thereof) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1303, a Digital Signal Processor (DSP) 1305, and a receiver/transmitter unit including a microphone gain control unit and a speaker gain control unit. A main display unit 1307 provides a display to the user in support of various applications and mobile station functions that offer automatic contact matching. An audio function circuitry 1309 includes a microphone 1311 and microphone amplifier that amplifies the speech signal output from the microphone 1311. The amplified speech signal output from the microphone 1311 is fed to a coder/decoder (CODEC) 1313.

A radio section 1315 amplifies power and converts frequency in order to communicate with a base station, which is included in a mobile communication system, via antenna 1317. The power amplifier (PA) 1319 and the transmitter/modulation circuitry are operationally responsive to the MCU 1303, with an output from the PA 1319 coupled to the duplexer 1321 or circulator or antenna switch, as known in the art. The PA 1319 also couples to a battery interface and power control unit 1320.

In use, a user of mobile station 1301 speaks into the microphone 1311 and his or her voice along with any detected background noise is converted into an analog voltage. The analog voltage is then converted into a digital signal through the Analog to Digital Converter (ADC) 1323. The control unit 1303 routes the digital signal into the DSP 1305 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 1325 for compensation of any frequency-dependent impairments that occur during transmission though the air such as phase and amplitude distortion. After equalizing the bit stream, the modulator 1327 combines the signal with a RF signal generated in the RF interface 1329. The modulator 1327 generates a sine wave by way of frequency or phase modulation. In order to prepare the signal for transmission, an up-converter 1331 combines the sine wave output from the modulator 1327 with another sine wave generated by a synthesizer 1333 to achieve the desired frequency of transmission. The signal is then sent through a PA 1319 to increase the signal to an appropriate power level. In practical systems, the PA 1319 acts as a variable gain amplifier whose gain is controlled by the DSP 1305 from information received from a network base station. The signal is then filtered within the duplexer 1321 and optionally sent to an antenna coupler 1335 to match impedances to provide maximum power transfer. Finally, the signal is transmitted via antenna 1317 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1301 are received via antenna 1317 and immediately amplified by a low noise amplifier (LNA) 1337. A down-converter 1339 lowers the carrier frequency while the demodulator 1341 strips away the RF leaving only a digital bit stream. The signal then goes through the equalizer 1325 and is processed by the DSP 1305. A Digital to Analog Converter (DAC) 1343 converts the signal and the resulting output is transmitted to the user through the speaker 1345, all under control of a Main Control Unit (MCU) 1303—which can be implemented as a Central Processing Unit (CPU) (not shown).

The MCU 1303 receives various signals including input signals from the keyboard 1347. The keyboard 1347 and/or the MCU 1303 in combination with other user input components (e.g., the microphone 1311) comprise a user interface circuitry for managing user input. The MCU 1303 runs a user interface software to facilitate user control of at least some functions of the mobile station 1301 to provide semantic category prediction. The MCU 1303 also delivers a display command and a switch command to the display 1307 and to the speech output switching controller, respectively. Further, the MCU 1303 exchanges information with the DSP 1305 and can access an optionally incorporated SIM card 1349 and a memory 1351. In addition, the MCU 1303 executes various control functions required of the station. The DSP 1305 may, depending upon the implementation, perform any of a variety of conventional digital processing functions on the voice signals. Additionally, DSP 1305 determines the background noise level of the local environment from the signals detected by microphone 1311 and sets the gain of microphone 1311 to a level selected to compensate for the natural tendency of the user of the mobile station 1301.

The CODEC 1313 includes the ADC 1323 and DAC 1343. The memory 1351 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1351 may be, but not limited to, a single memory, CD, DVD, ROM, RAM, EEPROM, optical storage, or any other non-volatile or non-transitory storage medium capable of storing digital data.

An optionally incorporated SIM card 1349 carries, for instance, important information, such as the cellular phone number, the carrier supplying service, subscription details, and security information. The SIM card 1349 serves primarily to identify the mobile station 1301 on a radio network. The card 1349 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A computer-implemented method comprising:
receiving a location subgraph specified at an arbitrary geographic granularity, the location subgraph comprising multi-modal relational location data associated with one or more location entities;
processing the location subgraph using a machine learning model to predict a semantic category representing the location subgraph, the one or more location entities in the location subgraph, or a combination thereof; and
providing the semantic category as an output.

2. The method of claim 1, wherein the semantic category is predicted from a predefined set of categories of interest.

3. The method of claim 2, wherein the machine learning model is trained using a supervised learning approach on an association between (1) a plurality of ground truth categories of the predefined site of categories of interest, and (2) a plurality of ground truth location entities.

4. The method of claim 2, wherein the machine learning model uses an unsupervised learning approach to cluster the multi-modal relational location data to determine the semantic category, the predefined set of categories of interest from which the semantic category is predicted, or a combination thereof.

5. The method of claim 1, wherein the location subgraph represents at least a part of a higher order location and wherein the one or more location entities in the location subgraph include one or more descendent nodes of the higher order location.

6. The method of claim 5, wherein the machine learning model learns one or more structural elements of the higher order location, and wherein the semantic category is predicted based at least in part on the one or more structural elements.

7. The method of claim 6, wherein the machine learning model is a graph neural network that encodes the one or more structural elements in one or more layers of the graph neural network.

8. The method of claim 7, wherein the one or more structural elements represents a spatial relationship, a semantic relationship, or a combination thereof among the one or more of location entities of the location subgraph.

9. The method of claim 1, wherein the multi-modal relational location data includes geographic location data, relative location data, place category data, imagery data, text data, context data, or a combination thereof associated with the one or more location entities, a geographic area in which the one or more entities are located, or a combination thereof.

10. The method of claim 1, wherein the multi-modal relational location data is retrieved from a third-party external semantic data source.

11. The method of claim 1, wherein the location subgraph represents the one or more location entities as one or more nodes and relationship information between the one or more location entities as one or more edges between the one or more nodes.

12. The method of claim 1, wherein the output is provided to a targeted marketing service, a navigation routing service, a recommendation service, or a combination thereof.

13. An apparatus comprising:
at least one processor; and
at least one memory including computer program code for one or more programs,
the at least one memory and the computer program code configured to, within the at least one processor, cause the apparatus to perform at least the following,
receive an input comprising one or more locations and context information associated with the one or more locations, the one or more locations are specified in the input at an arbitrary granularity;
use a machine learning model to predict a semantic category for the one or more locations at the arbitrary granularity; and
provide the predicted semantic category as an output.

14. The apparatus of claim 13, wherein the one or more locations are specified as a location subgraph of location graph comprising a plurality of nodes representing a plurality of location entities located in a geographic area and a plurality of edges between representing relationship information between the plurality of location entities.

15. The apparatus of claim 14, wherein the location subgraph represents at least a part of a higher order location and wherein the one or more location entities in the subgraph are descendent nodes of the higher order location.

16. The apparatus of claim 15, wherein the machine learning model learns one or more structural elements of the higher order location, and wherein the semantic category is predicted based at least in part on the one or more structural elements.

17. A non-transitory computer-readable storage medium for providing map embedding analytics for a neural network, carrying one or more sequences of one or more instructions which, when executed by one or more processors, cause an apparatus to perform:
receiving a location subgraph specified at an arbitrary geographic granularity, the location subgraph comprising multi-modal relational location data associated with one or more location entities;
processing the location subgraph using a machine learning model to predict a semantic category representing the location subgraph, the one or more location entities in the location subgraph, or a combination thereof; and
providing the semantic category as an output.

18. The non-transitory computer-readable storage medium of claim 17, wherein the semantic category is predicted from a predefined set of categories of interest.

19. The non-transitory computer-readable storage medium of claim 18, wherein the machine model is trained using a supervised learning approach on an association between (1) a plurality of ground truth categories of the predefined site of categories of interest, and (2) a plurality of ground truth location entities.

20. The non-transitory computer-readable storage medium of claim 18, wherein the machine model uses an unsupervised learning approach to cluster the multi-modal relational location data to determine the semantic category, the predefined set of categories of interest from which the semantic category is predicted, or a combination thereof.
